(19) United States
(12) Patent Application Publication
(10) Pub. No.: US 2016/0379244 A1
(43) Pub. Date: Dec. 29, 2016

(54) METHOD AND SYSTEM FOR FORECASTING A CAMPAIGN PERFORMANCE USING PREDICTIVE MODELING

(71) Applicant: Bidtellect, Inc., Delray Beach, FL (US)

(72) Inventors: Kristopher Kalish, Delray Beach, FL (US); Yuan-Chyuan Sheu, Boca Raton, FL (US); Jeremy Kayne, Boca Raton, FL (US); Michael Weaver, Parkland, FL (US); John Ferber, Delray Beach, FL (US); Lon Otremba, Boynton Beach, FL (US)

(73) Assignee: Bidtellect, Inc., Delray Beach, FL (US)

(21) Appl. No.: 14/747,706

(22) Filed: Jun. 23, 2015

(51) Int. Cl. G06Q 30/02; G06N 99/00; G06N 7/00

(52) U.S. Cl. CPC G06Q 30/0242; G06N 7/005; G06N 99/005

(57) ABSTRACT

The present teaching relates to forecasting a campaign performance using predictive modeling. In one example, a request for forecasting a campaign performance is received from a user. A plurality of parameters associated with the request are retrieved. A predictive score is generated based on the plurality of parameters. A variable vector is constructed based on one or more key performance indicators (KPIs) selected by the user. A campaign data matrix is generated in accordance with the predictive score based on the variable vector.

### CROSS-REFERENCE TO RELATED APPLICATION

The present application is related to a U.S. patent application having an attorney docketing No. 032583-0437493, filed on even date, entitled METHOD AND SYSTEM FOR FORECASTING A CAMPAIGN PERFORMANCE USING PREDICTIVE MODELING, which is incorporated herein by reference in its entirety.

### BACKGROUND

1. Technical Field

The present teaching relates to methods and systems for advertising. Specifically, the present teaching relates to methods and systems for forecasting a campaign performance.

2. Discussion of Technical Background

Online advertising involves the technologies and services for bidding and placing advertisements on websites. Advertisement serving entities may be categorized into two types: publisher advertisement servers (publishers) and advertiser (or third party) advertisement servers (advertisers). In recent online advertisement exchange network, additional intermediary parties may be involved in the advertisement serving process, including supply-side platforms (SSPs), which enable publishers to manage their advertising impression inventory and maximize revenue from digital media, demand-side platforms (DSPs), which allow advertisers to purchase advertising impressions across a range of publishers, and an ad exchange, which serves as a platform configured to facilitate the buying and selling of online media advertising inventory. Publishers make their advertisement impressions available through the ad exchange by SSPs, which automatically triggers bidding requests at the ad exchange. DSPs automatically determine which of advertisement impressions are more relevant to the associated advertisers' inventory, and submit the bids based on pre-configured campaign parameters on behalf of the advertisers.

Because the bids are automatically submitted to the ad exchange upon receiving a bidding request, it is difficult for the advertisers to know the likelihood of success of achieving a desired key performance indication using pre-configured campaign parameters, and to foresee the probability of successful sales after winning a bid. Further, the campaign parameters such as maximum budget, maximum bid, daily capping, goal type etc. may be pre-configured before a real campaign for an online advertising, or universally configured for all types of online advertising. Such out-of-date and universally configured campaign parameters may not satisfy the requirements of different campaign aspects, and may not reach the desired key performance indications in the online advertising

Therefore, there is a need to provide a resourceful solution to the advertisers to avoid the above-mentioned drawbacks.

### SUMMARY

The present teaching relates to methods and systems for advertising. Specifically, the present teaching relates to methods and systems for forecasting a campaign performance.

In one example, a method, implemented on a computing device having at least one processor, storage, and a communication platform capable of connecting to a network for forecasting a campaign performance using predictive modeling is disclosed. A request for forecasting a campaign performance is received from a user. A plurality of parameters associated with the request are retrieved. A predictive score is generated based on the plurality of parameters. A variable vector is constructed based on one or more key performance indicators (KPIs) selected by the user. A campaign data matrix is generated in accordance with the predictive score based on the variable vector.

In a different example, a system for forecasting a campaign performance using predictive modeling is disclosed. The system includes a user interface, a configuration unit, a first stage predicting unit, and a second stage predicting unit. The user interface is configured to receive from a user, a request for forecasting a campaign performance. The configuration unit is configured to retrieve a plurality of parameters associated with the request and construct a variable vector based on one or more KPIs selected by the user. The first stage predicting unit is configured to generate a predictive score based on the plurality of parameters. The second stage predicting unit is configured to generate a campaign data matrix in accordance with the predictive score based on the variable vector.

Other concepts relate to software for implementing the present teaching on forecasting a campaign performance using predictive modeling. A software product, in accord with this concept, includes at least one non-transitory machine-readable medium and information carried by the medium. The information carried by the medium may be executable program code data, parameters in association with the executable program code, and/or information related to a user, a request, content, or information related to a social group, etc.

In one example, a non-transitory machine readable medium having information recorded thereon for forecasting a campaign performance using predictive modeling is disclosed. The recorded information, when read by the machine, causes the machine to perform a series of processes. A request for forecasting a campaign performance is received from a user. A plurality of parameters associated with the request are retrieved. A predictive score is generated based on the plurality of parameters. A variable vector is constructed based on one or more KPIs selected by the user. A campaign data matrix is generated in accordance with the predictive score based on the variable vector.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1-2 illustrate exemplary system configurations in which a campaign predictive modeling and forecasting tool can be deployed, according to various embodiments of the present teaching;

FIG. 3 illustrates an exemplary bidding process where a campaign predictive modeling and forecasting tool is deployed, according to an embodiment of the present teaching;

FIG. 4 illustrates s an exemplary system diagram of a campaign predictive modeling and forecasting tool, according to an embodiment of the present teaching;

FIG. 5A illustrates an exemplary system diagram of a modeling module in a campaign predictive modeling and forecasting tool, according to an embodiment of the present teaching;

FIG. 5B illustrates an detailed exemplary diagram of a specified models a modeling module of a campaign predictive modeling and forecasting tool, according to an embodiment of the present teaching;

FIG. 6 is an exemplary system diagram of a forecasting module in a campaign predictive modeling and forecasting tool, according to an embodiment of the present teaching;

FIG. 7 is a flowchart of an exemplary process for predicting a campaign performance, according to an embodiment of the present teaching;

FIG. 8 is a flowchart of an exemplary process for predicting a campaign performance, according to another embodiment of the present teaching;

FIG. 9 is an exemplary system diagram of a forecasting module in a campaign predictive modeling and forecasting tool, according to another embodiment of the present teaching;

FIG. 10 is a flowchart of an exemplary process for predicting a campaign performance, according to yet another embodiment of the present teaching;

FIG. 11 is a flowchart of an exemplary process for predicting a campaign performance, according to yet another embodiment of the present teaching;

FIG. 12A is an exemplary forecasted success matrix, according to an embodiment of the present teaching;

FIG. 12B is an exemplary forecasted success matrix, according to yet another embodiment of the present teaching;

FIG. 13 depicts exemplary 2-D and 3-D figures that represent potential outputs of a forecasting module, according to an embodiment of the present teaching;

FIG. 14A illustrates an exemplary campaign network and estimated predictive scores using the campaign network, according to an embodiment of the present teaching;

FIG. 14B illustrates detailed configurations of the campaign network, according to an embodiment of the present teaching;

FIG. 14C is a flowchart of an exemplary process for predicting a new campaign performance, according to an embodiment of the present teaching;

FIG. 15 depicts the architecture of a mobile device which can be used to realize a specialized system implementing the present teaching; and

FIG. 16 depicts the architecture of a computing device which can be used to realize a specialized system implementing the present teaching.

### DETAILED DESCRIPTION

In the following detailed description, numerous specific details are set forth by way of examples in order to provide a thorough understanding of the relevant teachings. However, it should be apparent to those skilled in the art that the present teaching may be practiced without such details. In other instances, well known methods, procedures, components, and/or circuitry have been described at a relatively high-level, without detail, in order to avoid unnecessarily obscuring aspects of the present teaching.

The present teaching discloses a method, system, and programming aspects for forecasting a campaign performance using predictive modeling. As the forecasting applies a plurality of models that are trained regularly based on historical data, the forecasted result may provide the advertisers accurate estimation of the success probability of achieving desired key performances, and multiple forecasted key performances using the proposed campaign parameters. The advertisers may determine to adjust some of the campaign parameters to maximize their investment while still maintaining an overall performance level. In another embodiment, the forecasted result may provide the advertisers multiple desired campaign parameters in accordance with expected key performance. In such a way, the advertisers are provided with suggested campaign parameters, such as max budget, to meet an expected key performance, such as number of clicks. The present teaching can power the advertisers with an efficient tool to predict future campaigns, the return from the campaigns, and to make wise investment decisions on advertising their inventory.

Additional features will be set forth in part in the description which follows, and in part will become apparent to those skilled in the art upon examination of the following and the accompanying drawings or may be learned by production or operation of the examples. The features of the present teaching may be realized and attained by practice or use of various aspects of the methodologies, instrumentalities and combinations set forth in the detailed examples discussed below.

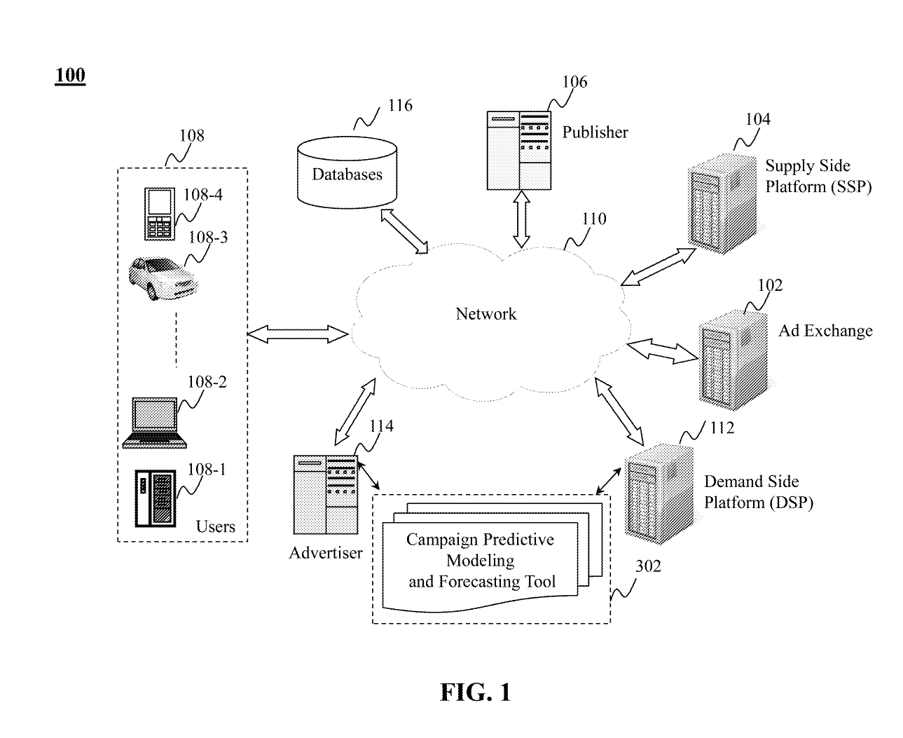

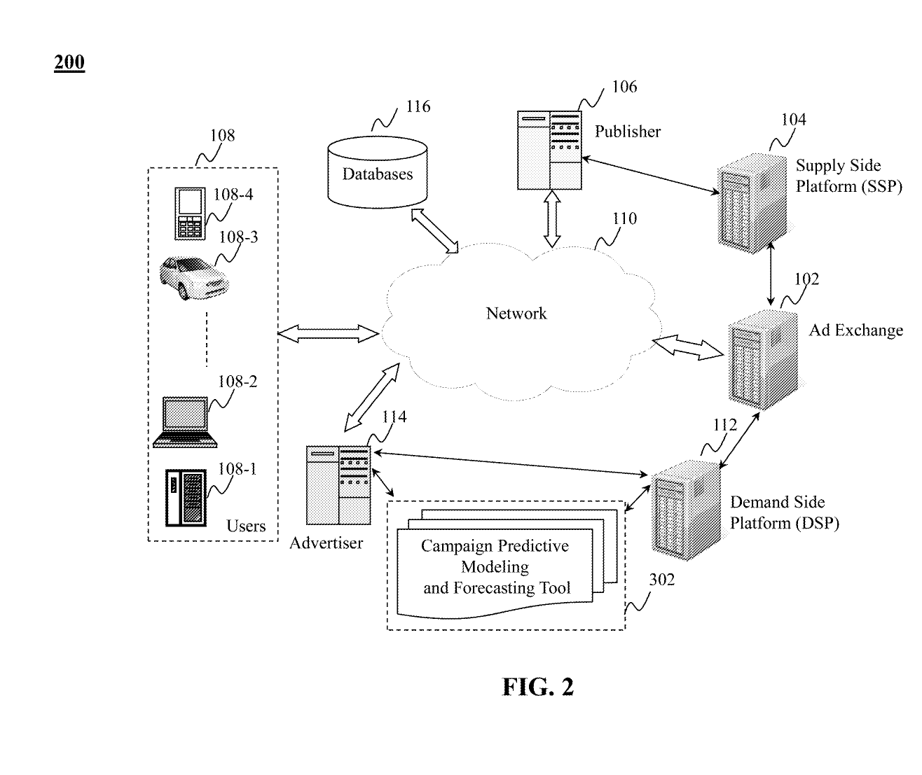

FIGS. 1-2 illustrate exemplary system configurations in which a campaign predictive modeling and forecasting tool can be deployed, according to various embodiments of the present teaching. In FIGS. 1-2, the exemplary systems include an ad exchange 102, a supply side platform (SSP) 104, a publisher 106, users 108, a network 110, a demand side platform (DSP) 112, an advertiser 114, one or more databases 116 and a campaign predictive modeling and forecasting tool 302.

The network 110 may be a single network or a combination of different networks. For instance, a network may be a local area network (LAN), a wide area network (WAN), a public network, a private network, a proprietary network, a Public Switched Telephone Network (PSTN), the Internet, a wireless network, a cellular network, a virtual network, or any combination thereof. A network may also include various network access points, e.g., wired or wireless access points such as base stations or Internet exchange points through which a data source may connect to the network 110 in order to transmit information via the network 110, and a network node may connect to the network 110 in order to receive information.

The users 108 may be of different types such as end users connected to the network 110 via desktop connections (108-1), users connecting to the network 110 via wireless connections such as through a laptop (108-2), a handheld device (108-4), or a built-in device in a mobile vehicle such as a motor vehicle (108-3). The users 108 may be connected to the network 110 and able to communicate with the publisher 106.

In this embodiment, the publisher 106 may be any entity that hosts one or more spaces in its assets (e.g., web sites, applications, etc.) for presenting content items, e.g., advertisements, to the users 108. The publisher 106 may also be a search engine, a blogger, a television station, a newspaper issuer, a web page host, a content portal, an online service provider, or a game server. The advertiser 114 may be any entity that provides inventory to be displayed on the publisher's webpage. The inventory may be electrical devices, fashion items, soft drinks, travel services, etc. The DSP 112 may be a platform configured to allow buyers of the advertising inventory to manage multiple ad exchange and data exchange accounts through one interface. The SSP 104 may be a platform configured with the single mission of enabling publishers to manage their advertising impression inventory and maximize revenue from digital media. In this embodiment, the one or more databases 116 may store information associated with advertisement campaign parameters, feedback data on won campaigns and placed advertisements, user databases, social databases, context databases etc.

In some embodiment, as will be described in further detail below, the campaign predictive modeling and forecasting tool 302 may be a back-end tool for advertisers to analyze the history campaign data and feedback data from won advertisements, load proposed parameters for future campaigns to simulate using selected predictive model, and provide a forecasted performance matrix to the advertisers. Therefore, the advertisers may have a first-hand understanding on how the proposed parameters will perform in a future advertisement campaign, and how to adjust the proposed parameters to achieve a particular KPI while maintain an overall success level.

In yet another embodiment, the campaign predictive modeling and forecasting tool 302 may collect expected key performance indicators (KPIs) as well as the proposed campaign parameters for simulation, and provide a forecasted campaign data matrix to the advertisers. Such a reverse prediction assists the advertisers to understand the campaign parameter requirements in order to achieve user-desired KPIs.

In FIG. 1, the publisher 106, SSP 104, ad exchange 102, DSP 112, and the advertiser 114 operate as independent service providers; while in FIG. 2, SSP 104 operates as a back-end sub-system of the publisher 106 for providing dedicated services to a particular publisher, and DSP 112 also operates as a back-end sub-system of the advertiser 114. Further in FIG. 2, the DSP 112 and SSP 104 exchange information with the ad exchange 102, which serves as an independent provider. The SSP 104 may forward impression opportunities released by the publisher 106 to the ad exchange 102, which is further forwarded to a plurality of advertisers via DSP 112. In response, the plurality of advertisers 114 may submit a plurality of bids to the ad exchange 102 via DSP 112. The highest bid for an available impression is generated at the ad exchange and forwarded to the publisher 106 via SSP 104.

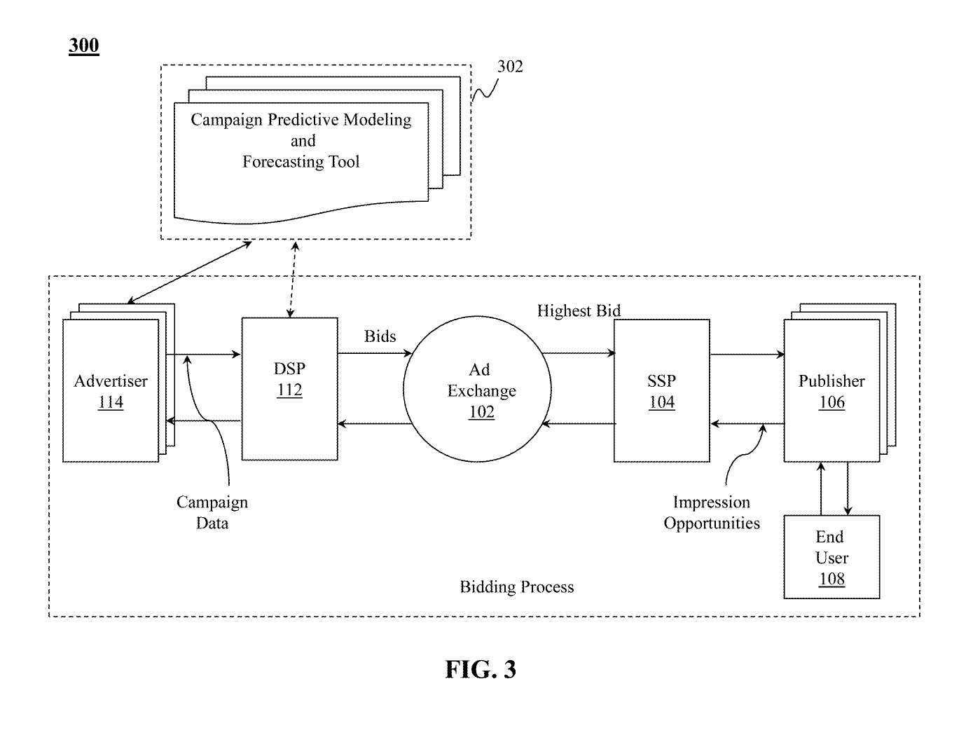

FIG. 3 illustrates an exemplary bidding process where a campaign predictive modeling and forecasting tool is deployed, according to an embodiment of the present teaching. According to this embodiment a bidding process begins with an end user 108 visiting a website, i.e., the publisher 106. This automatically triggers an impression opportunity that may include various types of information such as the end user's demographic information, browsing behavior in the past, location of the end user, and the particular webpage being loaded to the end user's computer device. The impression opportunity may be released to ad exchange 102 via SSP 104 as a bidding request, where the ad exchange 102 serves as a platform configured to facilitate the buying and selling of online media advertising inventory. The bidding request may be automatically forwarded to associated advertisers via DSP 112. In response, these associated advertisers may propose a set of campaign parameters in accordance with the requirements related to the available advertising space at the publisher, and submit their bids for the available advertising space at the publisher to the ad exchange 102 via DSP 112. The multiple advertisers may bid on each advertising impression as it is served. It is determined at the ad exchange 102 that the impression goes to the highest bidder and their ad is served on the webpage. The bidding process is performed for every available advertising slot on the webpage.

According to the present embodiment, before an actual bid is submitted to the ad exchange 102 in response to a bidding request, the advertiser 114 may perform a back-end analysis on the proposed campaign data to forecast a possible campaign result. A set of pre-configured campaign parameters are loaded into the campaign predictive modeling and forecasting tool 302. The campaign predictive modeling and forecasting tool 302 may be deployed on a DSP associated with the particular advertiser, or a DSP that operates independently. In some embodiment, the campaign predictive modeling and forecasting tool 302 may be deployed on some other computing device such as a server, and the advertiser 114 may communicate the campaign predictive modeling and forecasting tool 302 through a network. The campaign predictive modeling and forecasting tool 302 may select an appropriate predictive model to forecast the campaign result based on the set of pre-configured campaign parameters. The campaign predictive modeling and forecasting tool 302 may provide the forecasted campaign result in multiple formats, and gives the advertiser 114 an offline opportunity to adjust the proposed campaign parameters to achieve a desired performance.

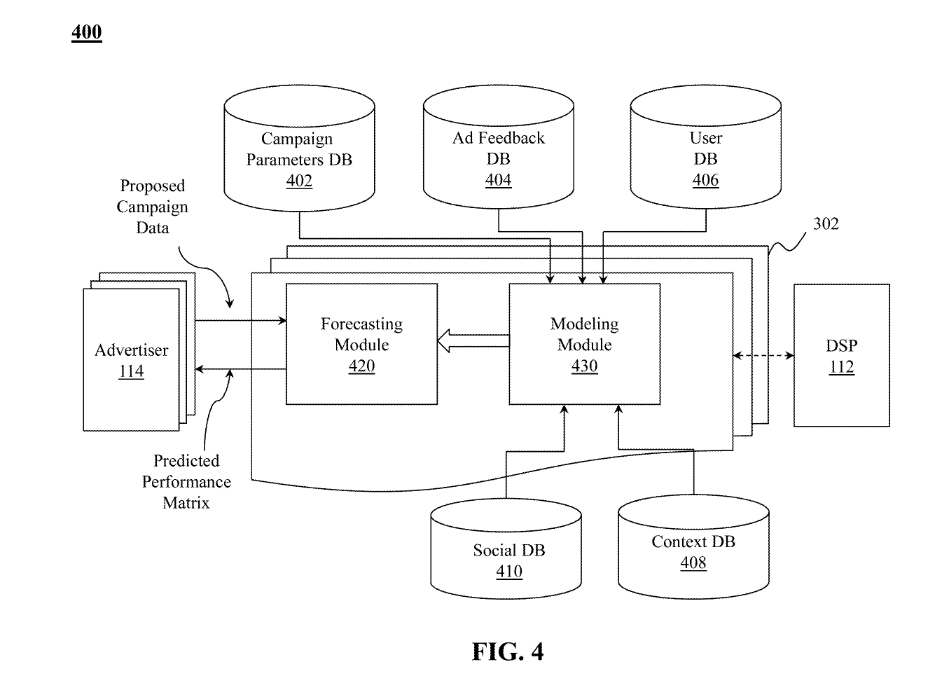

FIG. 4 is an exemplary system diagram of a campaign predictive modeling and forecasting tool, according to an embodiment of the present teaching. The campaign predictive modeling and forecasting tool may comprise a forecasting module 420 and a modeling module 430. Upon receiving proposed campaign data from the advertiser 114, the forecasting module 420 may select one or more predictive models from the modeling module 430, and perform analysis and forecasting using the proposed campaign data. A predicted performance matrix is further generated and returned to the advertiser 114. The modeling module 430 may perform an offline modeling based on historical data such as campaign parameters used in previous ad biddings, feedback data from previously placed ads, user demographics and browsing history, social trending data, context data related to supply sources. The modeling module 430 may adopt a plurality of algorithms such as weighted moving average, exponential smoothing, trend estimation, regression analysis, data mining, machine learning, pattern recognition, probabilistic forecasting, etc. In some embodiment, the algorithms may be statistic based methods, but the algorithms may be artificial intelligence methods such as fuzzy logic, or the combination of one or more of the methods set forth above. The parameters of each of the adopted algorithm are trained using the historical data. As the historical data refreshes quickly each day, the model training may be trained on a regular basis, For instance, a scheduled weekly training, such that the campaign predictive modeling and forecasting tool can provide more accurate forecasting of future campaigns.

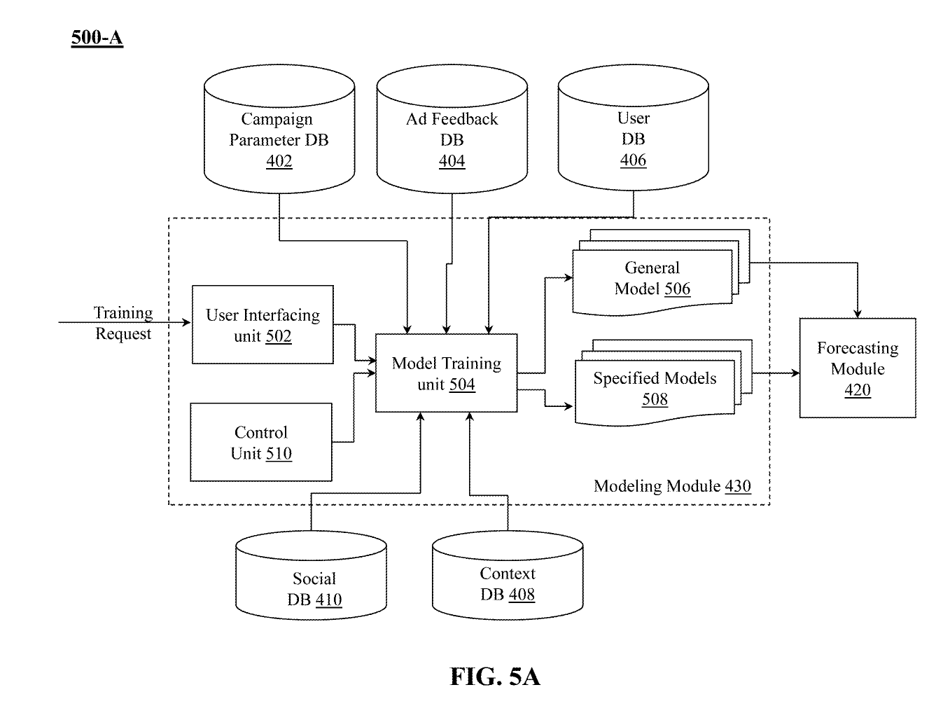

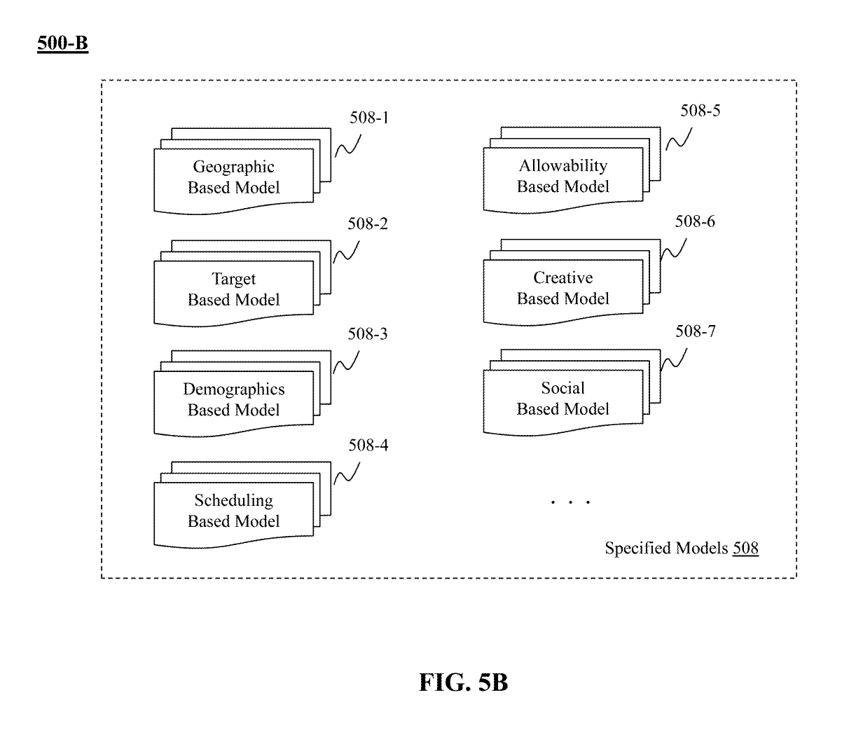

FIG. 5A is an exemplary system diagram of a modeling module in a campaign predictive modeling and forecasting tool, according to an embodiment of the present teaching. The modeling module in this embodiment may include a user interfacing unit 502 configured to receive a training request from a user, a model training unit 504 configured to train a plurality of predictive models, a control unit 510 configured to select the predictive model to be trained and organize types of data retrieved from the campaign parameter DB 402, the ad feedback DB 404, the user DB 406, the social DB 410, and the context DB 408 for the model training. The predictive models to be trained in the modeling module 430 may be classified into a general model 506 and one or more specified models 508 in accordance with different forecasting goals. In some embodiment, when an overall campaign performance is desired regardless of the end user's location, the impression scheduling, the impression allowability, etc., the modeling module 430 may select the general model 506 to forecast the campaign result based on the proposed parameters. In yet another embodiment, when the performance dedicated in a specific location is desired, the modeling module 430 may select a corresponding model from the one or more specified models 506 to forecast the campaign result based on the proposed parameters. It is understood that the user in this embodiment may be an advertiser, a DSP, or a third-party partner, and is different from the end user 108 shown in FIG. 3.

FIG. 5B is a detailed exemplary diagram of a specified models a modeling module of a campaign predictive modeling and forecasting tool, according to an embodiment of the present teaching. The specified predictive models 508 in FIG. 5A may include a geographic based model 508-1, a target based model 508-2, a demographic based model 508-3, a scheduling based model 508-4, an allowability based model 508-5, a creative based model 508-6, a social based model 508-7, etc. The geographic based model 508-1 may be configured to forecast how a set of campaign parameters perform on a geographic location. For instance, a beer or sports drinks advertisement placed on Seattle Seahawk's webpage may receive more clicks than those placed on Washington Redskin's webpage. The target based model 508-2 may be configured to forecast how a set of campaign parameters perform with respect to a targeted inventory, For instance, computer accessories, home goods, fashion items, etc. The demographic based model 508-3 may be configured to forecast how a set of campaign parameters perform with respect to the demographic information of the end users. For instance, an Apple watch advertisement may receive more clicks from male customers than female customers. The scheduling based model 508-4 may be configured to forecast how a set of campaign parameters perform with respect to different displaying scheduling. For instance, an advertisement of Christmas decorations may receive huge clicks during November and December, and sporadic clicks beyond the holiday season. The allowability based model 508-5 may be configured to forecast how a set of campaign parameters perform with respect to the categories, sites, or spots where the advertisements are placed. For instance, a popular website or an up-to-front view of the advertisement may attract more customers to click and view the advertisement. The creative based model 508-6 may be configured to forecast how a set of campaign parameters perform with respect to the information created for the advertisement. For instance, an image-based advertisement may receive more clicks than a textual advertisement. The social based model 508-7 may be configured to forecast how a set of campaign parameters perform with respect to the social trends. For instance, cyclic activities around finance are observed while analyzing social media. These cyclic activities may correspond to the open and close of the New York stock exchange. The social based model 508-7 may be trained to discover correlations between such activities and CTR for finance related advertisements.

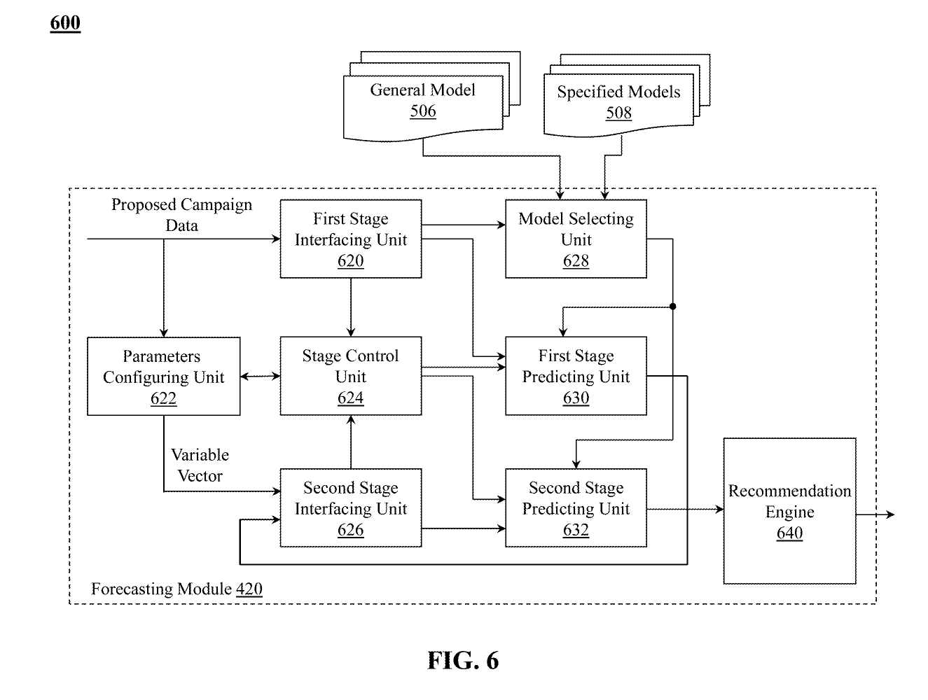

FIG. 6 is an exemplary system diagram of a forecasting module in a campaign predictive modeling and forecasting tool, according to an embodiment of the present teaching. The forecasting module in this embodiment includes a first stage interfacing unit 620, a parameters configuring unit 622, a stage control unit 624, a second stage interfacing unit 626, a model selecting unit 628, a first stage predicting unit 630, and a second stage predicting unit 632. The proposed campaign data is loaded to the first stage interfacing unit 620, which triggers the stage control unit 624 to turn on the first stage predicting unit 630. The first stage predicting unit 630 is configured to select a predictive model via the model selecting unit 628, and calculate a predictive score that represents an overall performance using the proposed campaign data. The predictive score is further transmitted to the second stage interfacing unit 626, which triggers the stage control unit 624 to turn on the second stage predicting unit 632. Meantime, the stage control unit 624 instructs the parameters configuring unit 622 to construct a variable vector based on one or more of the plurality of campaign parameters selected by the user. The constructed variable vector and the predictive score are inputted into the second stage predicting unit 632 to calculate a forecasted performance matrix, which may comprise one or more KPIs.

The forecasting module in this embodiment may further include a recommendation engine 640 to interface with the users, for instances, advertisers. The recommendation engine 640 is configured to present configuration suggestions to the users on how to configure the parameters of campaign data to achieve the user-desired key performance indication level if the forecasted KPIs do not satisfy the preset goal. This is particularly helpful in the circumstance when the forecasting module 420 predicts a small chance of success. The users may configure the parameters having greatest influence on the KPI such as maximum budget, maximum bid, flight parameters, etc., to increase the chance of success. However, there may be other non-obvious factors that also greatly impact the performance of a campaign such as targeting a different audience or category of sites, as used in the specified models 508. The present teaching captures those non-obvious factors that also have great influence on the campaign performance during the model training stage, and recommends the users with one or more scenarios to configure their campaign parameters to improve their chance of success.

The proposed campaign data may comprise maximum budget, maximum bid, bidding type, bidding frequency, daily cap, pacing type, goal type, creative, allowability, etc. According to different stage of calculation, one or more parameters may be selected as variables at the second stage calculation. Each variable may be configured with a set of experimental values. By varying one or more campaign parameters, the forecasting module may be able to present the performance change in accordance with the varied campaign data. In this embodiment, the performance matrix may comprise one or more KPI values such as number of clicks, number of impressions, conversion rate, click through rate, conversion per impression, cost per conversion, cost per click, cost per 1000 impressions, win rate, and engagement score, etc.

The predictive score in this embodiment may be a function or model of the initially proposed campaign data, which is:

Predictive Score=ƒ(initially proposed campaign data), (1)

where ƒ is a selected function to calculate the predictive score at the first stage predicting unit 630.

The second stage predicting unit 632 receives the predictive score and a variable vector based on one or more campaign parameters as inputs, and calculates the forecasted performance matrix using function g, which is:

Forecasted performance matrix=g(predictive score,campaign parameter variables). (2)

The variable vector is constructed by selecting at least one campaign parameter and assigning a set of experimental values to the selected parameter, while maintaining the rest of the campaign parameters as constants. The purpose of constructing the campaign vector is to predict the performance variance in accordance with the selected variable from the campaign parameters. Predicting the performance variance of a campaign facilitates the user, i.e., the advertisers, to compare different levels of inputs and the corresponding outputs and further adjust the campaign parameters to achieve the desired performance. In some embodiment, the function g used in the second stage predicting unit 632 may use the same algorithm(s) as function ƒ used in the first stage predicting unit 630. Yet in some other embodiments, the function g used in the second stage predicting unit 632 may use a different algorithm(s) from function fused in the first stage predicting unit 630.

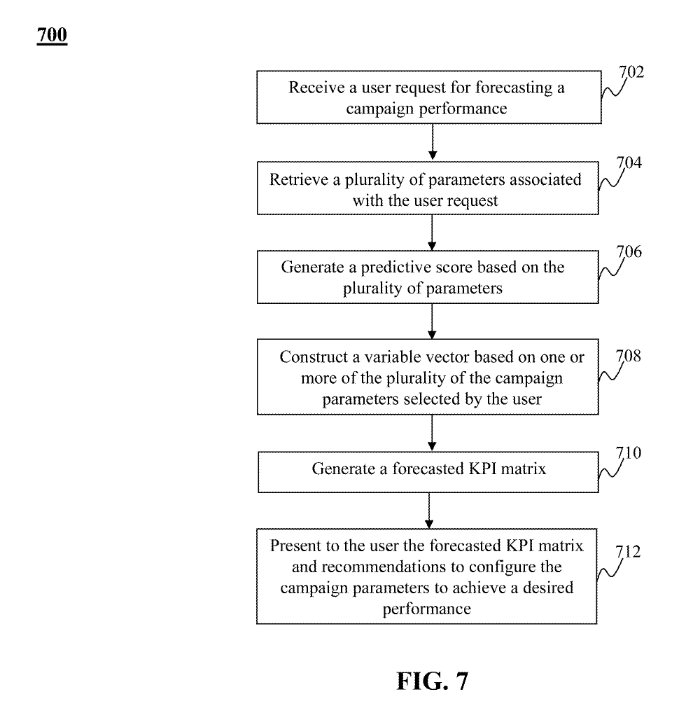

FIG. 7 is a flowchart of an exemplary process for predicting a campaign performance, according to an embodiment of the present teaching. At step 702, a user request for forecasting a campaign performance is received. At step 704, a plurality of parameters associated with the user request is retrieved for a first stage prediction. At step 706, a predictive score is generated based on the received plurality of parameters from the user request. At step 708, a variable vector is constructed based on one or more of the plurality of campaign parameters selected by the user. And at step 710, a forecasted KPI matrix is generated.

In some embodiment, the process for predicting a campaign performance may further include presenting to the user the forecasted KPI matrix and recommendations to configure the campaign parameters to achieve a desired performance at step 712. The present teaching may provide the user one or more scenarios on how to select and configure the campaign data parameters to achieve a desired key performance. Therefore, the presentation to the user may include a first part of the forecasted performance, i.e., the KPI matrix, based on the initially proposed campaign parameters; and at least a second part of the forecasted performance based on the adjusted campaign parameters. The one or more recommendation scenarios may include the parameters having greatest influence on the KPI such as maximum budget, maximum bid, flight parameters as well as other non-obvious factors that also have great influence on the campaign performance. This greatly facilitates the user to determine which factor he/she wants to adjust based on the business needs yet still achieving the desired campaign performance.

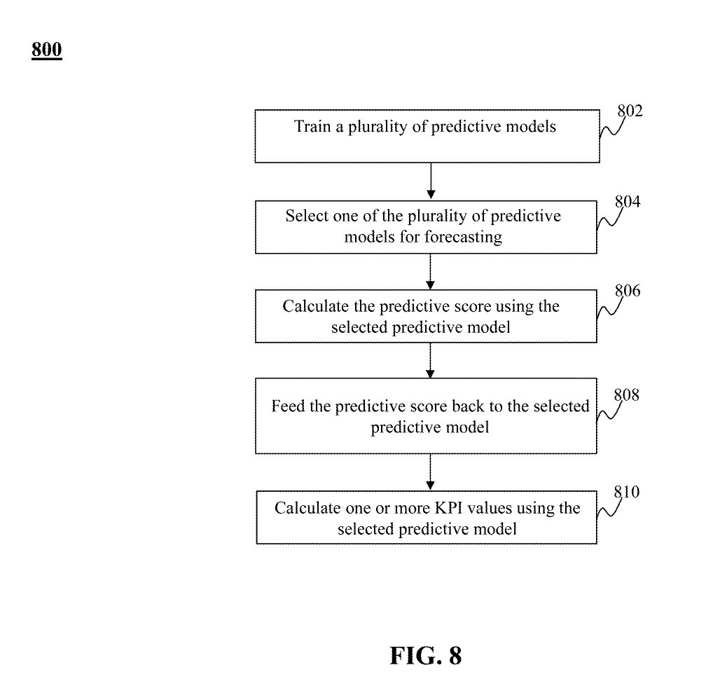

FIG. 8 is a flowchart of an exemplary process for predicting a campaign performance, according to another embodiment of the present teaching. At step 802, a plurality of predictive models are trained using historical data. At step 804, one of the plurality of predictive models for forecasting is selected. At step 806, the predictive score is calculated using the selected predictive model. At step 808, the predictive score is fed back to the selected predictive model. At step 810, one or more KPI values are calculated using the selected predictive model.

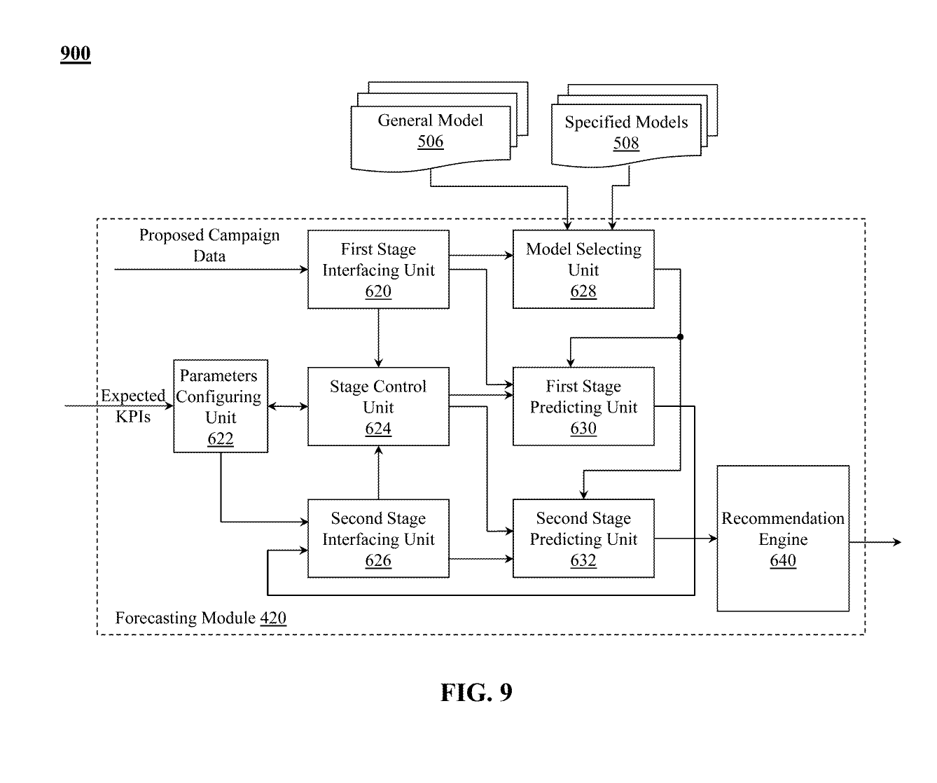

FIG. 9 is an exemplary system diagram of a forecasting module in a campaign predictive modeling and forecasting tool, according to another embodiment of the present teaching. The system diagram of a forecasting module in this embodiment includes same elements as shown in FIG. 6, except that the parameters configuring unit 622 performs differently from FIG. 6. After a first stage predictive calculation, the second stage interfacing unit 626 receives the calculated predictive score, a KPI variable vector based on one or more KPIs selected by the user, and a second stage predictive calculation is performed on the second stage predicting unit 632. The second stage predictive calculation outputs a forecasted campaign matrix that is suggested to meet the expected KPIs from the input.

Similar to the embodiment shown in FIG. 6, the predictive score in this embodiment may be a function of the initially proposed campaign data, which is:

Predictive Score=ƒ(initially proposed campaign data). (3)

The second stage predicting unit 632 receives the predictive score and a KPI variable vector based on one or more key performance indications (KPIs) as inputs, and estimates the forecasted campaign data matrix using function g, which is:

Estimated campaign data matrix=g(predictive score,KPI variables). (4)

The KPI variable vector is constructed by selecting at least one KPI parameter and assigning a set of experimental values to the selected KPI parameter, while maintaining other KPI parameters as constants. The purpose of constructing the KPI variable vector is to estimate the requirement changes on the campaign data in accordance with the desired KPIs. Estimating the requirement changes on the campaign data helps the user, i.e., the advertisers, to determine an optimal campaign dataset in order to achieve a desired performance. In some embodiment, the function g used in the second stage predicting unit 632 may use the same algorithm(s) as function ƒ used in the first stage predicting unit 630. Yet in some other embodiments, the function g used in the second stage predicting unit 632 may use a different algorithm(s) from function fused in the first stage predicting unit 630.

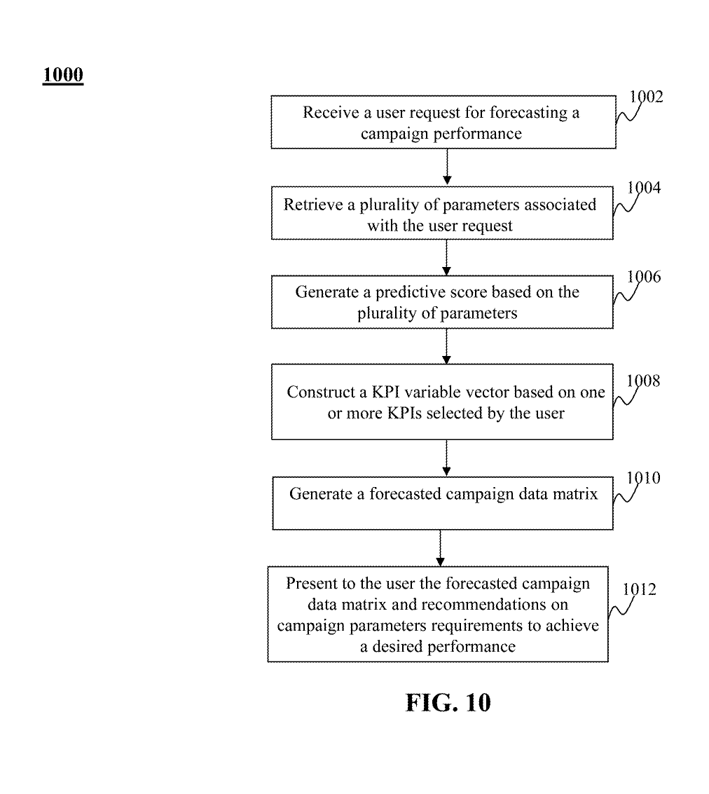

FIG. 10 is a flowchart of an exemplary process for predicting a campaign performance, according to yet another embodiment of the present teaching. At step 1002, a user request for forecasting a campaign performance is received. At step 1004, a plurality of parameters associated with the user request is retrieved for a first stage prediction. At step 1006, a predictive score is generated based on the received plurality of parameters from the user request. At step 1008, a KPI variable vector is constructed based on one or more KPIs selected by the user. And at step 1010, a forecasted campaign data matrix is generated.

In some embodiment, the process for predicting a campaign performance may further include presenting to the user the forecasted campaign data matrix and recommendations on campaign parameters requirements to achieve a desired performance at step 1012. The present teaching may provide the user one or more scenarios on the potential requirements of the campaign data parameters to achieve a desired key performance. Therefore, the presentation to the user may include a first part of the forecasted performance, i.e., the campaign data matrix, based on the user desired performance indication; and at least a second part of the forecasted performance based on the adjusted user desired performance indication. This embodiment can help the user to determine an optimal campaign dataset based on the business needs yet still achieving the desired campaign performance.

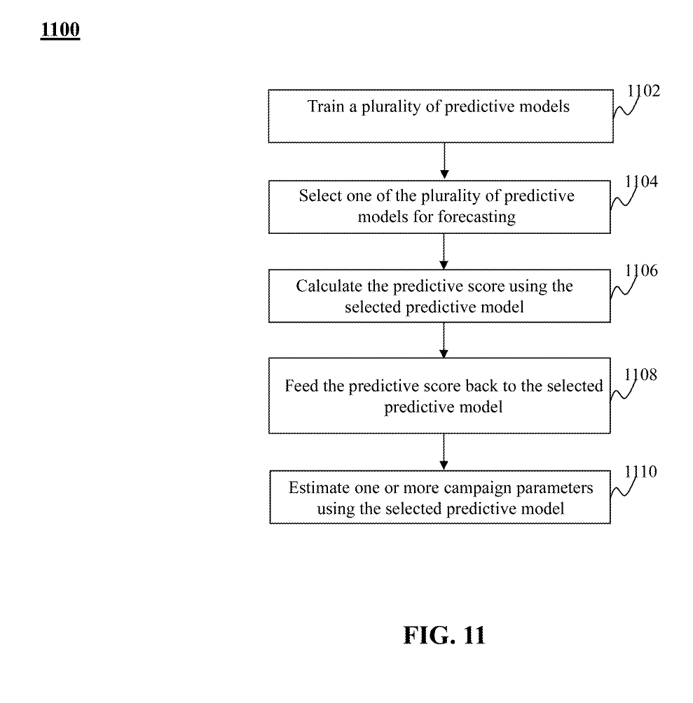

FIG. 11 is a flowchart of an exemplary process for predicting a campaign performance, according to yet another embodiment of the present teaching. At step 1102, a plurality of predictive models are trained using historical data. At step 1104, one of the plurality of predictive models for forecasting is selected. At step 1106, the predictive score is calculated using the selected predictive model. At step 1108, the predictive score is fed back to the selected predictive model. At step 1110, one or more campaign parameters are estimated using the selected predictive model.

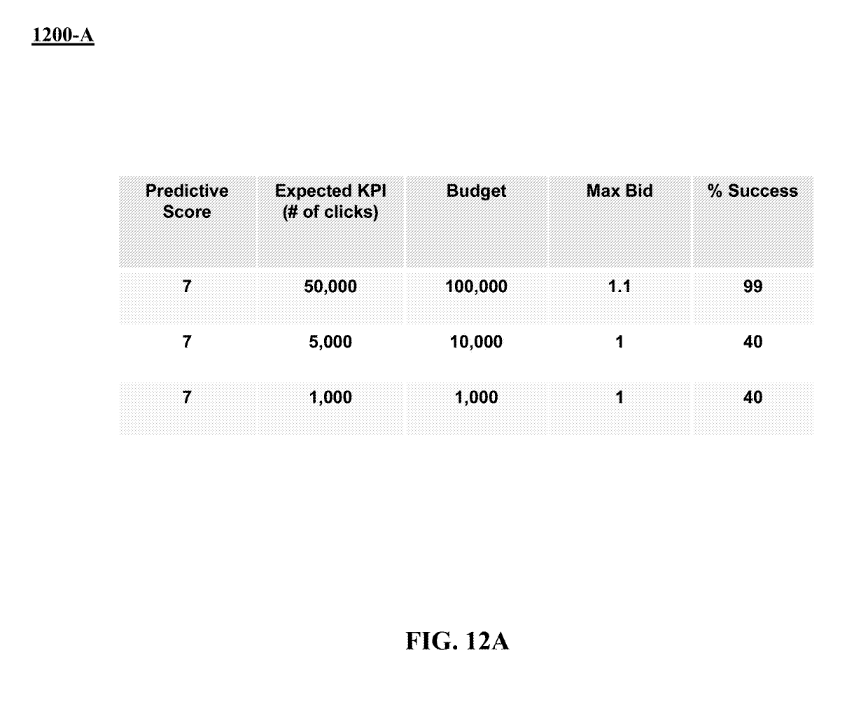

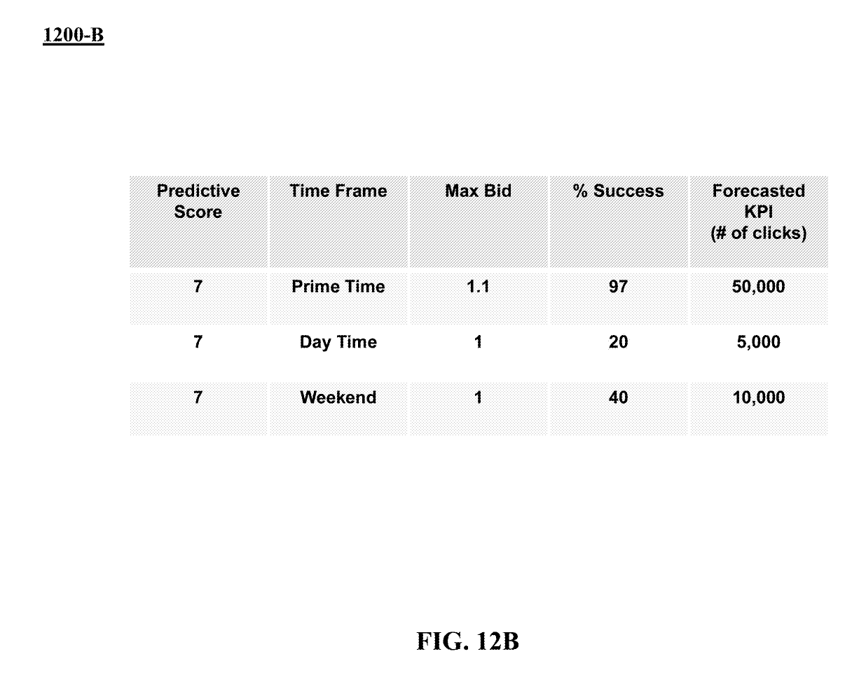

FIG. 12A is an exemplary forecasted success matrix, according to an embodiment of the present teaching. In this embodiment, the predictive score is 7 indicating a medium to top performance of a future campaign. While maintaining the overall medium to top performance, the success matrix provides desired maximum budgets to achieve an expected KPI, and chances that the proposed campaign parameters may win a bid. For instance, if the number of clicks is expected to be 50,000, with a max bid to be $1.1, the desired max budget is $100,000, and the likely success rate of winning the bid is 99%. Further, if the number of clicks is expected to be 5,000, with a max bid to be $1, the desired max budget is $10,000, and the likely success rate of winning the bid is 40%; and if the number of clicks is expected to be 1,000, with a max bid to be $1, the desired max budget is $1,000, and the likely success rate of winning the bid is 40%. According to this embodiment, the KPI variable vector comprises at least expected number of clicks. The success matrix as presented provides the advertisers multiple options to adjust the campaign parameters to achieve an expected KPI while still maintaining an overall level of performance. In addition, the success matrix provides an estimated likelihood of success by investing a certain amount of money on bidding an impression.

FIG. 12B is an exemplary forecasted success matrix, according to yet another embodiment of the present teaching. In this embodiment, the predictive score is 7 indicating a medium to top performance of a future campaign. While maintaining the overall medium to top performance, the success matrix provides forecasted KPIs using a scheduling based predictive model. For instance, during a prime time period (e.g., 8 am-9 am), a constant max budge with max bid of $1.1 renders approximate 50,000 clicks and a likely success rate 99% of winning the bid; during other day time period, a same constant max budget with max bid of $1 renders approximate 5,000 clicks and a likely success rate 20% of winning the bid; and during weekend time period, a same constant max budget with max bid of $1 renders approximate 10,000 clicks and a likely success rate 40% of winning the bid. In this embodiment, the variable vector comprises different time frames that an advertisement is shown.

It is understood that the success matrix is not limited to the examples set forth above. The campaign predictive modeling and forecasting tool may provide various types of success matrix in accordance with the user's needs. Multiple success matrices and any combination of the multiple success matrices may assist the advertisers to deploy their ads strategies. For instance, an advertiser may invest $100,000 for placing an ad during prime time to expect 50,000 clicks, and $10,000 for placing the same ad during other day time to expect 5,000 clicks. Referenced by the multiple success matrices, an advertiser can distribute its investment into a plurality of portions with respect to different aspects of the campaign.

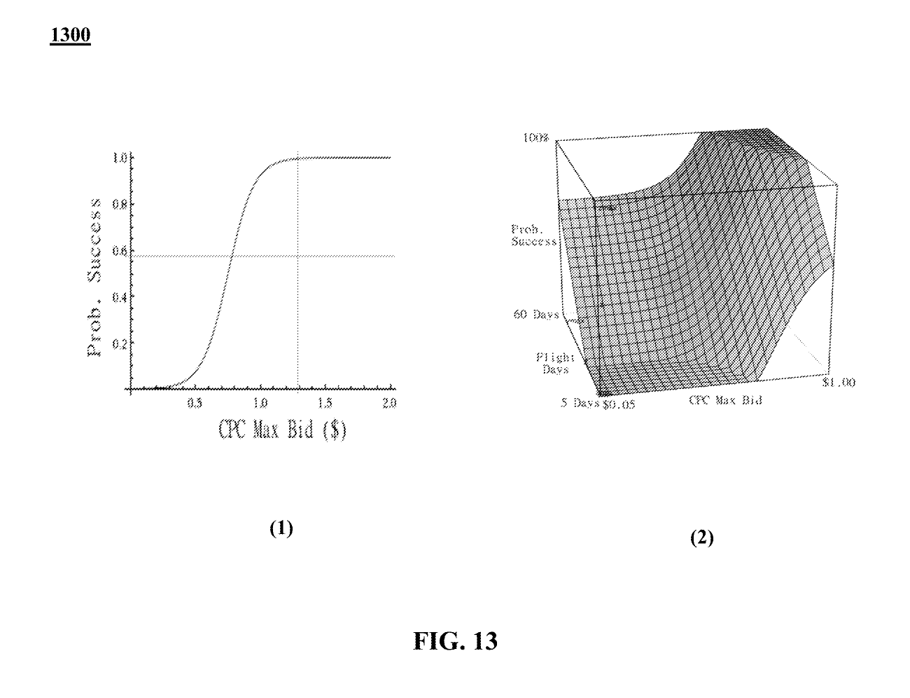

FIG. 13 depicts exemplary 2-D and 3-D figures that represent potential outputs of a forecasting module, according to an embodiment of the present teaching. FIG. 13-(1) shows a simulated relationship between a proposed cost per click (CPC) max bid and a predicted probability of success. In this simulation, the CPC max bid is the selected variable, and varies between the value of 0 and 2. All other campaign parameters such as maximum budget, flights, etc. are set as constants. As illustrated in FIG. 13-(1), CPC max bid lower than $0.5 receives approximately 10% chance of success. As the CPC max bid increases from $0.5 to $1.0, the probability of success improves steadily from 10% to nearly 90%. The probability of success reaches 100% when the CPC max bid is raised to approximately 1.3. FIG. 13-(2) shows simulated relationships between the predicted probability of success, the CPC max bid, and the length of flight in days. In this simulation, the CPC max bid, and the length of flight in days are two selected variables. The CPC max bid varies between the value of 1 and 2, and the length of flights in days varies between 5 days and 60 days. Comparing to the simulation of FIG. 13-(1) where only one campaign parameter is set as a variable, the simulation of FIG. 13-(2) demonstrates how two campaign parameters interact with one another. For instance, in running a 5 day campaign, there is no chance of success unless the CPC max bid is very high. Meanwhile, the flat plateau at the top indicates that there is no reason to run a campaign more than 50 days with a CPC max bid of $0.8 because the chance of success is already certain, i.e., 100%.

By constructing and training various specified predictive models with respect to different campaign aspects, the modeling and forecasting tool may provide the advertisers with aspect oriented result which is more accurate in forecasting the campaign performance with respect to a particular aspect. Further, by forecasting one or more aspect oriented results, the advertisers may choose different aspects to deploy advertising their inventory to optimize the investment in terms of profit return.

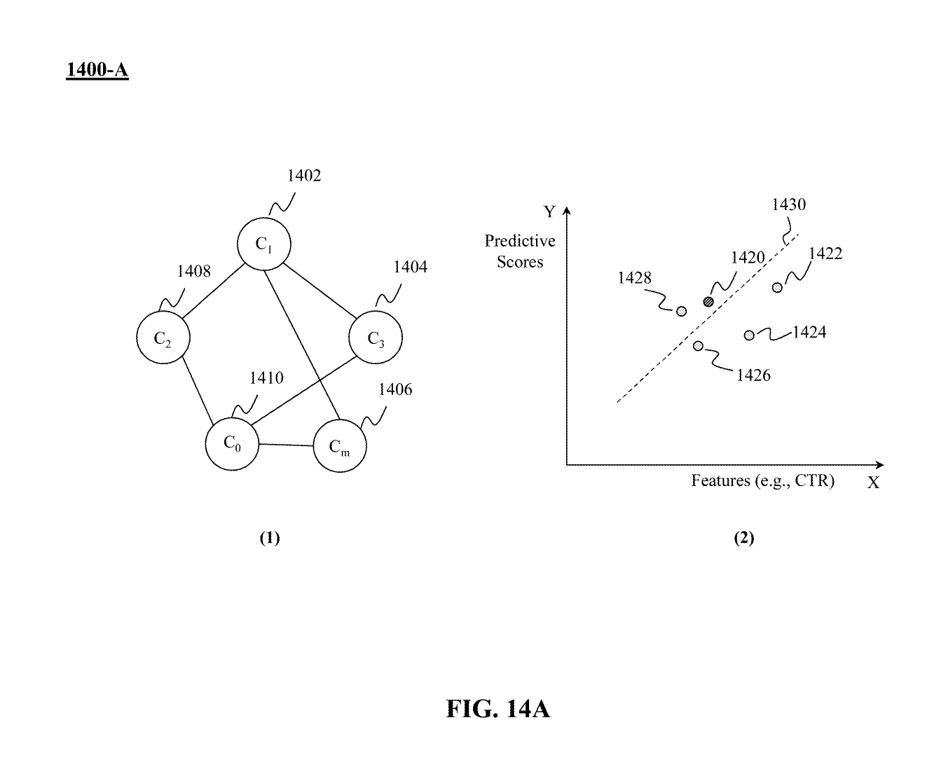

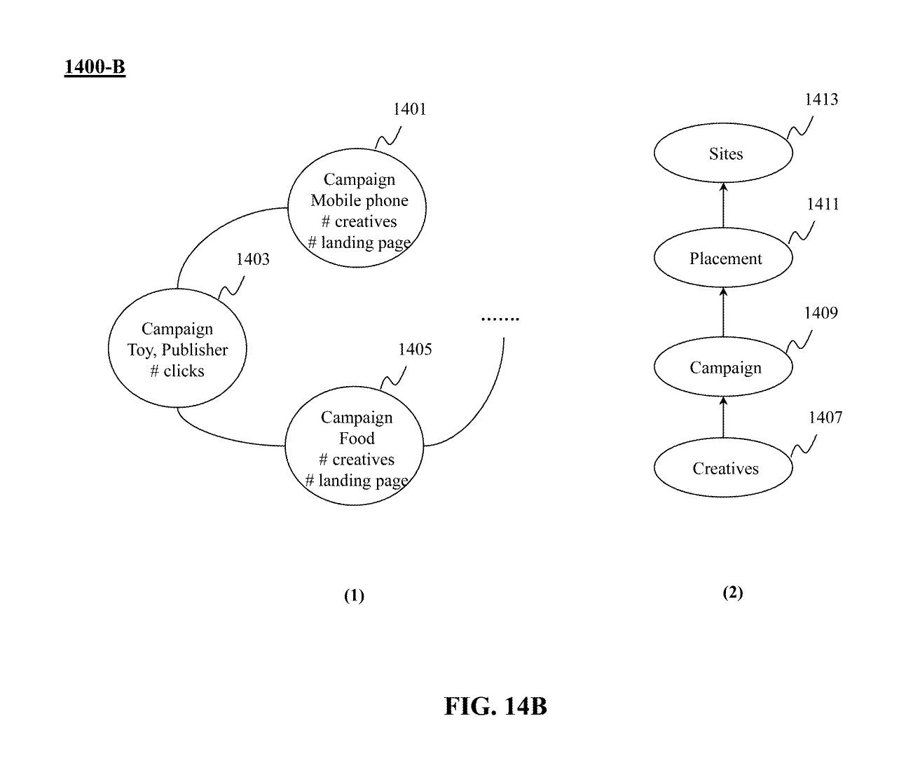

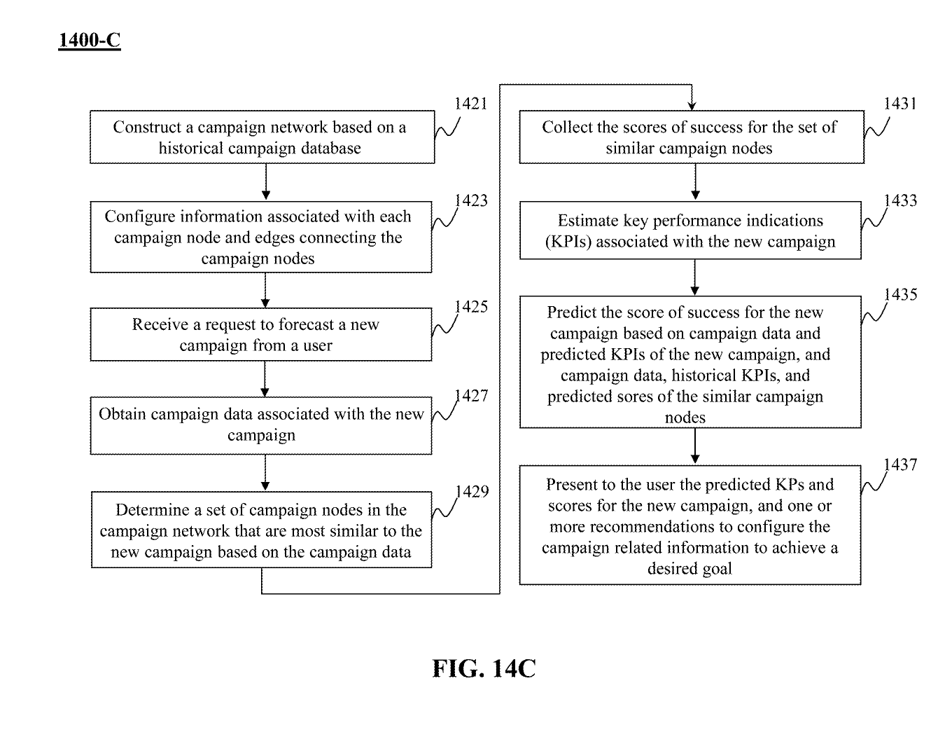

FIG. 14A illustrates an exemplary campaign network and estimated predictive scores using the campaign network, according to an embodiment of the present teaching. The present teaching may build the underlying data structure via constructing a number of campaigns as a graphic network as shown in FIG. 14A-(1). Each individual campaign is modeled as a node in the campaign network, for instance, nodes 1402, 1404, 1406, 1408, and 1410 represent campaigns C₁, C₃, Cₘ, C₂, and C₀, respectively. The connection between two nodes, i.e., the edge connection in the campaign network, represents the relationship between the corresponding two campaigns. Campaign score prediction according to this embodiment employs a two-stage forecasting framework, which (1) predicts the future score of any existing campaign inside the network or available in a database, and (2) predicts a future score of a new campaign. Further, the predictive score is calculated according to a case-based reasoning principle, which selects a set of campaigns similar to an exemplar campaign, and calculates the predictive score based on the reduced campaign set.

### 1. Predict Future Score of an Existing Campaign C₀.

Using the node and edge connection information associated with the constructed campaign network, the forecasting framework selects a set of historical campaigns denoted as C₁, C₂, C₃, . . . , Cₘ with highest correlation with existing campaign C₀. For each user interested KPI such as CTR, the forecasting framework collects corresponding KPI values from campaigns C₁, C₂, C₃, . . . , Cₘ, and runs a multi-variant time series model based on the collected KPI from the historical campaigns to predict the future score of the existing campaign C₀.

Table 1 listed categorized information associated with the historical campaigns C1, C₂, C₃, . . . , Cₘ, as well as a rated predictive score for each of the historical campaigns. The rated predictive scores are collected based on customer feedback or any other measurement criteria, for instance, customer satisfaction levels associated with the historical campaigns. As shown in Table 1, the rated predictive score of campaign C₀ is to be predicted using the information associated with campaigns C₀, C1, C₂, C₃, . . . , Cₘ, and the rated predictive scores of campaigns C1, C₂, C₃, . . . , Cₘ.

TABLE 1

| Cam- | | | Average | | | Rated |
|---|---|---|---|---|---|---|
| paign | Campaign | Geographic | CTR | | # | Predictive |
| index | budget | target | (%) | . . . | conversion | Score |
| C₁ | $20,000 | FL, GA, AL | 0.9 | | 1,200 | 7 |
| C₂ | $50,000 | USA | 1.2 | | 8,000 | 82 |
| C₃ | $1,000 | NYC | 0.4 | | 100 | 6 |
| . . . | | | | | | |
| Cₒ | $10,000 | FL | 0.08 | | 70 | ? |

Campaign network constructed based on Table 1 is shown in FIG. 14A-(1). The set of campaigns C₁, C₂, C₃, and Cₘ are most similar to campaign C₀, and may be called as nearest neighbors of C₀. The forecasting framework further applies the case-based reasoning principle to predict the rated predictive score for campaign C₀.

FIG. 14A-(2) illustrates an example of estimated predictive score for campaign C₀. The X-axis denotes a preset feature, e.g., CTR, and the Y-axis denotes the predictive score. Campaign C₀ is denoted as dot 1420, and its nearest neighboring campaigns are denoted as dots 1422, 1424, 1426, and 1428. The forecasting framework uses information associated with neighboring campaigns 1422, 1424, 1426, and 1428 to run a piecewise regression model (shown as the dashed line 1430). Assume the piecewise regression model is represented as H(x=CTR), the function to predict the score of campaign C₀ is shown as:

P(C₀'s predictive score|CTR)=H(x=C₀CTR). (5)

In some embodiment, the forecasting framework may use similar approaches to derive multiple predictive scores for campaign C₀, and calculate a final score for campaign C₀ using an ensemble approach as shown below:

P(C₀'s predictive score)=α₁×P(C₀ predictive score|CTR)+α₂×P(C₀ predictive score|#conversations)+ . . . +αₘ×P(C₀ predictive score|campaign Budget), (6)

Where α₁, α₂, . . . , and αₘ are weight values determining the quality of each prediction based on respective features. A high quality prediction will receive a large weight value and therefore, contributes more to the final score prediction for campaign C₀.

### 2. Predict Score for a New Campaign Cₓ.

In some embodiment when a user submits a request to predict score and/or performance for a new campaign Cₓ with limited campaign data, the forecasting framework may employ a two-stage approach to estimate the score and the performance. The forecasting framework first collects features associated with the new campaign including but not limited to ad tags, maximum budget, campaign lifetime, geographic constraints, etc. Further, the forecasting framework determines the similarity between new campaign Cₓ and the campaigns established in the campaign network, and selects a set of campaigns that are most similar to the new campaign. The forecasting framework applies the case-based reasoning principle set forth above to predict one or more future KPI values for each of the set of campaigns, and further predicts the score for the new campaign based on the one or more predicted future KPI values of the set of campaigns.

Table 2 shows a prospective campaign Cₓ whose statistic information such as CTR, number of conversations and predictive score are to be predicted. The only information available associated with the new campaign Cₓ is the campaign budget.

TABLE 2

| Cam- | | | Average | | | Rated |
|---|---|---|---|---|---|---|
| paign | Campaign | Geographic | CTR | | # | Predictive |
| index | budget | target | (%) | . . . | conversion | Score |
| C₁ | $20,000 | FL, GA, AL | 0.9 | | 1,200 | 7 |
| C₂ | $50,000 | USA | 1.2 | | 8,000 | 82 |
| C₃ | $1,000 | NYC | 0.4 | | 100 | 6 |
| . . . | | | | | | |
| Cₒ | $10,000 | FL | 0.08 | | 70 | 6.5 |
| Cₓ | $15,000 | CA | ? | | ? | ? |

At stage 1, the forecasting framework predicts the KPI values for the new campaign Cₓ shown in Table 3. For instance, the forecasting framework predicts the average CTR, number of conversations, etc., for the new campaign Cₓ.

TABLE 3

| Cam- | | | Average | | | Rated |
|---|---|---|---|---|---|---|
| paign | Campaign | Geographic | CTR | | # | Predictive |
| index | budget | target | (%) | . . . | conversion | Score |
| C₁ | $20,000 | FL, GA, AL | 0.9 | | 1,200 | 7 |
| C₂ | $50,000 | USA | 1.2 | | 8,000 | 82 |
| C₃ | $1,000 | NYC | 0.4 | | 100 | 6 |
| . . . | | | | | | |
| Cₒ | $10,000 | FL | 0.08 | | 70 | 6.5 |
| Cₓ | $15,000 | CA | 0.076 | | 200 | ? |

At stage 2, when the KPI values for the new campaign Cₓ are available, the forecasting framework predicts the score using all associated with the campaigns and the including the new campaign Cₓ, and rated predictive scores of the neighboring campaigns. The case-based reasoning principle to predict the score for a further campaign has been elaborated above and is not repeated in detail herewith.

FIG. 14B illustrates detailed configurations of the campaign network, according to an embodiment of the present teaching. As shown in FIG. 14B-(1), each node of the campaign network is a historical campaign, and is configured to include information associated with the historical campaign such as ad tags, publishers, target, creatives, landing pages, average CTR, revenues, etc. The edge connecting two nodes quantifies the strength of correlation between two campaigns. For instance, campaign 1401 and campaign 1403 have strong correlation in the CTR scores observed during the lifetime period of the campaigns, and are therefore connected. Meanwhile, campaign 1403 and campaign 1405 are connected due to their strong correlation in the campaign site. Each node in the campaign network may be connected to any other node in accordance with various correlation aspects. As a new campaign node is added to the network, the information associated with the new campaign may be compared with the nodes already established in the campaign network to determine the correlations with those nodes.

In some embodiment, the information associated with an edge connecting two nodes may include multiple levels of correlation between the two nodes. For instance, the edge connecting campaign 1401 and campaign 1403 may indicate a strong correlation in the CTR score as well as a medium level correlation in the campaign site. Further, the edge information associated with the campaign network may be periodically updated, or updated when a new campaign node gets added.

In some embodiment, each campaign node is configured to be a hierarchical structure as shown in FIG. 14B-(2). From upper levels to lower levels, informative granularity increase allowing fine-grained granularity for denoting a campaign network. For instance, the hierarchical structure of a campaign node may include but not limited to a creative level 1407, a campaign level 1409, a placement level 1411, and a site level 1413. Each node shown in FIG. 14B-(1) may be viewed at different levels. Accordingly, different aspect of campaign networks may be formed in accordance to a preset hierarchical level, for instance, a placement network, a site network, or a network combined with multiple nodes in different aspects of the hierarchical structure.

FIG. 14C is a flowchart of an exemplary process for predicting a new campaign performance, according to an embodiment of the present teaching. The process for predicting a new campaign performance comprises receiving a request to forecast a new campaign from a user at step 1425, obtaining campaign data associated with the new campaign at step 1427, determining a set of historical campaigns that are most similar to the new campaign based on the obtained campaign data at step 1429, collecting the scores of success for the set of the similar campaigns at step 1431; estimating key performance indications associated with the new campaign at step 1433, predicting the score of success for the new campaign based on campaign data and predicted KPIs of the new campaign, and campaign data, historical KPIs, and predicted sores of the similar campaign nodes at step 1435, and presenting to the user the predicted KPs and scores for the new campaign, and one or more recommendations to configure the campaign related information to achieve a desired goal at step 1437.

In some embodiment, the process for predicting a new campaign performance may further comprise constructing a campaign network based on a historical campaign database at step 1421, and configuring information associated with each campaign node and edges connecting the campaign nodes at step 1423. The information associated with a campaign node may include all historical campaign data and feedbacks on the historical campaign. The information associated with edges connecting the campaign nodes may indicate any types of correlations between two campaigns, and quantized levels of the correlations. Additional information may be supplemented into the campaign nodes and the edge by users or administrators of the campaign network. The campaign network information may be updated periodically or when a new campaign node is added to the network.

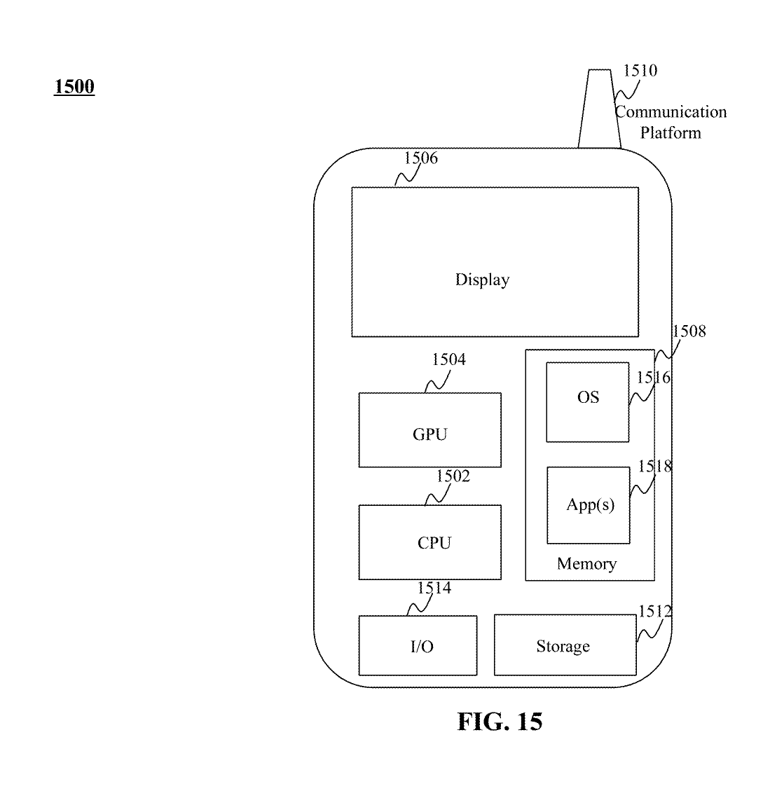

FIG. 15 depicts the architecture of a mobile device which can be used to realize a specialized system implementing the present teaching. In this example, the user device on which content is presented and interacted with is a mobile device 1500, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1500 in this example includes one or more central processing units (CPUs) 1502, one or more graphic processing units (GPUs) 1504, a display 1506, a memory 1508, a communication platform 1510, such as a wireless communication module, storage 1512, and one or more input/output (I/O) devices 1514. Any other suitable component, including but not limited to a system bus or a controller (not shown), may also be included in the mobile device 1500. As shown in FIG. 15, a mobile operating system 1516, e.g., iOS, Android, Windows Phone, etc., and one or more applications 1518 may be loaded into the memory 1508 from the storage 1512 in order to be executed by the CPU 1502. The applications 1518 may include a browser or any other suitable mobile apps for receiving and interacting with content on the mobile device 1500. User interactions with the content may be achieved via the I/O devices 1514 and provided to the campaign predictive modeling and forecasting tool via communication platform 1510.

To implement various modules, units, and their functionalities described in the present disclosure, computer hardware platforms may be used as the hardware platform(s) for one or more of the elements described herein (e.g., the campaign predictive modeling and forecasting tool 302 described with respect to FIGS. 1-14). The hardware elements, operating systems and programming languages of such computers are conventional in nature, and it is presumed that those skilled in the art are adequately familiar therewith to adapt those technologies to campaign performance forecasting as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

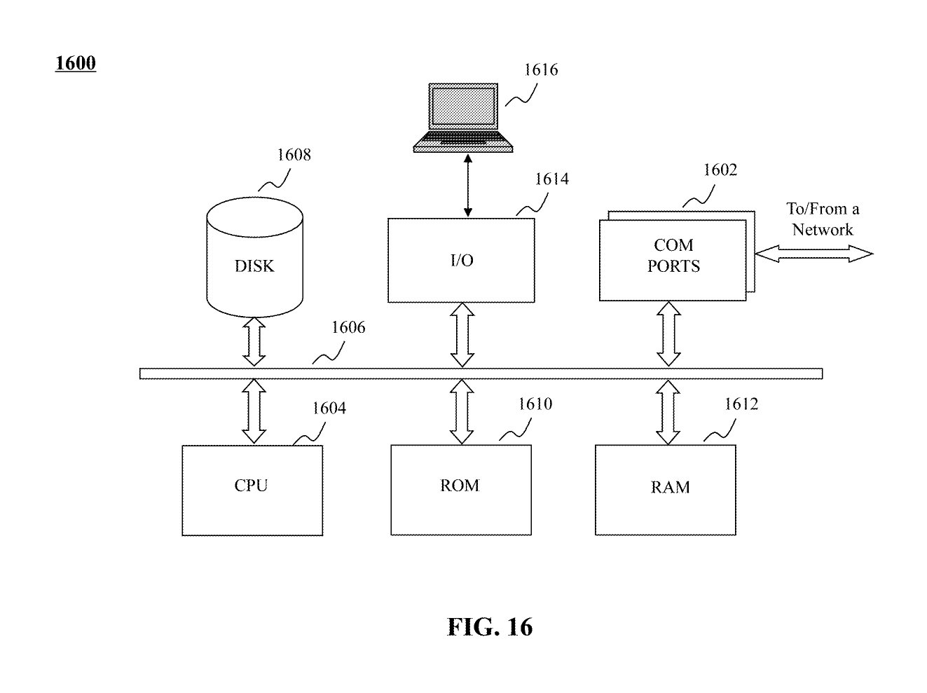

FIG. 16 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1600 may be used to implement any component of campaign performance forecasting techniques, as described herein. For instance, the campaign predictive modeling and forecasting tool 302, etc., may be implemented on a computer such as computer 1600, via its hardware, software program, firmware, or a combination thereof. Although only one such computer is shown, for convenience, the computer functions relating to campaign performance forecasting as described herein may be implemented in a distributed fashion on a number of similar platforms, to distribute the processing load.

The computer 1600, For instance, includes COM ports 1602 connected to and from a network connected thereto to facilitate data communications. The computer 1600 also includes a central processing unit (CPU) 1604, in the form of one or more processors, for executing program instructions. The exemplary computer platform includes an internal communication bus 1606, program storage and data storage of different forms, e.g., disk 1608, read only memory (ROM) 1610, or random access memory (RAM) 1612, for various data files to be processed and/or communicated by the computer, as well as possibly program instructions to be executed by the CPU 1604. The computer 1600 also includes an I/O component 1614, supporting input/output flows between the computer and other components therein such as user interface elements 1616. The computer 1600 may also receive programming and data via network communications.

A further embodiment of the present teaching applies the campaign predictive modeling and forecasting tool to provide a reach-frequency analysis to user, i.e., advertisers. The reach-frequency analysis may provide the users with the segment they want to target and the budget they plan to spend, the number of unique users that can be reached and at what distribution of frequency (for instance, 80% of the audience see at least 3 times the same impression), the number of clicks and conversions from the unique users, etc.

From the user campaign budget and targeting segment, the reach-frequency analysis model configures the size of the audience (for instance, in market for a new mobile phone) in the segment to be N, and estimates a total number of impressions that the client's budget can buy using M=1000×X/Y, where M is the total number of impressions, X is the client's budget, and Y is the cost of buying 1000 impressions (CPM).

In some embodiment, the reach-frequency analysis model assumes the serving of each impression is an independent event, and therefore, at the time of serving an impression, the probability of the impression being served to a particular audience is 1/N. The chance of having exactly n impressions on a single cookie is determined based on the probability theory as:

$$( \begin{matrix}M \\ n\end{matrix} ) \times {( 1 - \frac{1}{N} )}^{M - n} \times {( \frac{1}{N} )}^{n} = \frac{M !}{n ! ( M - n ) !} \times {( 1 - \frac{1}{N} )}^{M - n} \times {( \frac{1}{N} )}^{n} \\ where n != 1 \times 2 \times 3 … \times n . \qquad ( 7 )$$

For a given campaign, the reach-frequency analysis model may estimate the chance of having exactly n impressions on a single cookie at the end of the campaign, and the number of audience getting served 0 impression, 1 impression, 2 impressions, . . . , etc. For instance, the number of audience getting served 0 impression, i.e., unreachable to the audience, can be estimated as:

$$N \times {( 1 - \frac{1}{N} )}^{M} \qquad ( 8 )$$

In some embodiment, a normal distribution shown below may be used to approximate the above binomial distribution:

$$N ( \frac{M}{N} , M \times \frac{1}{N} \times ( 1 - \frac{1}{N} ) ) \qquad ( 9 )$$

where N (0, 1) denotes the standard normal distribution.

Once the numbers of audience receiving respective impression levels are estimated, the reach-frequency analysis model may apply the predictive modeling and forecasting methodology to compute the number of clicks, the number of conversions, etc., at each level of impressions being served. In some embodiment, the reach-frequency analysis model may ultimately compute the number of clicks from a unique audience at the end of the campaign.

Hence, aspects of the method of forecasting a campaign performance, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, For instance, may enable loading of the software from one computer or processor into another, For instance, from a management server or host computer of a search engine operator into the hardware platform(s) of a computing environment or other system implementing a computing environment or similar functionalities in connection with campaign performance forecasting. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, For instance, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include For instance: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teaching is amenable to a variety of modifications and/or enhancements. For instance, although the implementation of various components described above may be embodied in a hardware device, it can also be implemented as a software only solution—e.g., an installation on an existing server. In addition, the campaign performance forecasting as disclosed herein can be implemented as a firmware, firmware/software combination, firmware/hardware combination, or a hardware/firmware/software combination.

While the foregoing has described what are considered to constitute the present teaching and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teaching.

1. A method, implemented on a computing device having at least one processor, storage, and a communication platform capable of connecting to a network for estimating one or more campaign parameters using predictive modeling, the method comprising:
receiving, at the computer device, campaign data related to a campaign, wherein the campaign data include one or more proposed values for the one or more campaign parameters;
estimating, at a computer device, a predictive score of the campaign based on the campaign data;
constructing a variable vector based on one or more key performance indicators (KPIs) selected by the user;
estimating, at the computer device, at least one value of the one or more campaign parameters to achieve a campaign performance indicator based on the predictive score;
comparing, at the computer device, the at least one value with the campaign data to identify;
one or more scenarios, wherein the one or more scenarios provide one or more recommended values of the one or more campaign parameters to adjust the campaign data to achieve the campaign performance indicator; and
providing the one or more scenarios in at least one user interface of the computer device, wherein the user interface is partitioned into a first part and a second part, and wherein the first part of the user interface presents the predictive score and the second part of the user interface presents the one or more expected key performance indicators.

2. The method of claim 1, further comprising:
training, at the computer device, a plurality of predictive models; and
selecting, at the computer device, one of the plurality of predictive models for estimating the one or more campaign parameters,
wherein each of the plurality of predictive models is configured with one or more algorithms, and is trained based on historical data.

3. The method of claim 2, further comprising:
calculating, at the computer device, the predictive score using the selected predictive model;
feeding, by the computer device, the predictive score back to the selected predictive model; and
calculating, at the computer device, the at least one value of one or more campaign parameters using the selected predictive model.

4. The method of claim 2, wherein the plurality of predictive models include a general model and at least one specified model comprising types of a target based model, a demographics based model, a scheduling based model, an allowability based model, a creative based model, and a social based model.

5. The method of claim 1, wherein the one or more campaign parameters comprise maximum budget, maximum bid, bidding type, bidding frequency, daily cap, pacing type, and goal type.

6. The method of claim 1, wherein the predictive score indicates a success level of the campaign using the provided campaign data.

7. A system having at least one processor, storage, and a communication platform for estimating one or more campaign parameters using predictive modeling, the system comprising:
a user interface unit implemented on the at least one processor that receives campaign data related to a campaign, wherein the campaign data include one or more proposed values for the one or more campaign parameters;
a first stage predicting unit implemented on the at least one processor that estimates a predictive score of the campaign based on the campaign data; and
a second stage predicting unit implemented on the at least one processor that estimates at least one value of the one or more campaign parameters to achieve a campaign performance indicators based on the predictive score; and
a recommendation engine implemented on the at least one processor that compares the at least one value with the campaign data to identify one or more scenarios, wherein the one or more scenarios provide one or more recommended values of the one or more campaign parameters to adjust the campaign data to achieve the campaign performance indicator, and
provides the one or more scenarios in at least one user interface of the user interface unit, wherein the user interface is partitioned into a first part and a second part, and wherein the first part of the user interface presents the predictive score and the second part of the user interface presents the one or more expected key performance indicators.

8. The system of claim 7, further comprising:
a model training unit implemented on the at least one processor that trains a plurality of predictive models; and
a model selecting unit implemented on the at least one processor that selects one of the plurality of predictive models for estimating the one or more campaign parameters,
wherein each of the plurality of predictive models is configured with one or more algorithms, and is trained based on historical data.

9. The system of claim 8, wherein
the first stage predicting unit further:
calculates the predictive score using the selected predictive model; and;
the second stage predictive unit further:
receives the predictive score as a feedback input; and
estimates one or more campaign parameters using the selected predictive model, wherein each of the one or more campaign parameters corresponds to one of the variable vector.

10. The system of claim 8, wherein the plurality of predictive models include a general model and at least one specified model comprising types of a target based model, a demographics based model, a scheduling based model, an allowability based model, a creative based model, and a social based model.

11. The system of claim 7, wherein the one or more campaign parameters comprise maximum budget, maximum bid, bidding type, bidding frequency, daily cap, pacing type, and goal type.

12. The system of claim 7, wherein the predictive score indicates a success level of the campaign using the provided campaign data.

13. A non-transitory machine-readable medium having information recorded thereon for estimating one or more campaign parameters using predictive modeling, wherein the information, when read by the machine, causes the machine to perform the following:
receiving, at a computer device, campaign data related to a campaign, wherein the campaign data include one or more proposed values for the one or more campaign parameters;
estimating, at the computer device, a predictive score of the campaign based on the campaign data;
estimating, at the computer device, at least one value of the one or more campaign parameters to achieve a campaign performance indicator based on the predictive score;
comparing, at the computer device, the at least one value with the campaign data to identify;
one or more scenarios, wherein the one or more scenarios provide one or more recommended values of the one or more campaign parameters to adjust the campaign data to achieve the campaign performance indicator; and
providing the one or more scenarios in at least one user interface of the computer device, wherein the user interface is partitioned into a first part and a second part, and wherein the first part of the user interface presents the predictive score and the second part of the user interface presents the one or more expected key performance indicators.

14. The medium of claim 13, further comprising:
training, at the computer device, a plurality of predictive models; and
selecting, at the computer device, one of the plurality of predictive models for estimating the one or more campaign parameters,
wherein each of the plurality of predictive models is configured with one or more algorithms, and is trained based on historical data.

15. The medium of claim 14, further comprising:
calculating, at the computer device, the predictive score using the selected predictive model;
feeding, by the computer device, the predictive score back to the selected predictive model; and
calculating, at the computer device, the at least one value of one or more campaign parameters using the selected predictive model.

16. The medium of claim 14, wherein the plurality of predictive models include a general model and at least one specified model comprising types of a target based model, a demographics based model, a scheduling based model, an allowability based model, a creative based model, and a social based model.

17. The medium of claim 13, wherein the one or more campaign parameters comprise maximum budget, maximum bid, bidding type, bidding frequency, daily cap, pacing type, and goal type.

18. The medium of claim 13, wherein the predictive score indicates a success level of the campaign using the provided campaign data.
